(19) United States
(12) Patent Application Publication
(10) Pub. No.: US 2008/0024401 A1
(43) Pub. Date: Jan. 31, 2008

(54) OPTICALLY ADDRESSED AND DRIVEN LUMINESCENT DISPLAY

(76) Inventor: Jon Vierling DeGroot, Midland, MI (US)

Correspondence Address: WILLIAMS, MORGAN & AMERSON, 10333 RICHMOND, SUITE 1100, HOUSTON, TX, 77042, US

(21) Appl. No.: 11/778,310

(22) Filed: Jul. 16, 2007

Related U.S. Application Data
(60) Provisional application No. 60/820,509, filed on Jul. 27, 2006.

(51) Int. Cl. G09G 3/30

(52) U.S. Cl. 345/81

(57) ABSTRACT

The present invention provides a method and apparatus for optically addressing and driving a luminescent display. The method includes providing at least one light ray to a first location on a first surface of a waveguide at a first angle relative to the first surface such that said at least one light ray emerges from a second location on a second surface of the waveguide proximate at least one pixel. The second location is determined based on the first angle.

### BACKGROUND OF THE INVENTION

1. Field of the Invention

This invention relates generally to luminescent displays, and, more particularly, to optically addressed and driven luminescent displays.

2. Description of the Related Art

Flat panel video displays are becoming increasingly popular, at least in part because they provide a relatively large area to display images while requiring a comparatively thin device package. The large ratio of image area to device thickness allows flat panel video displays to be used in a variety of environments that are typically inaccessible to conventional cathode ray tube displays. For example, flat panel video displays may be used as a monitor for a conventional desktop computer, a monitor for a laptop computer, a television screen, a display for a personal data assistant, a display for a cellular telephone, a display for a navigation system in an automobile, and the like.

However, the size of a conventional flat panel display may be limited by a resistance/capacitance switching time of row and/or column transparent conductors in the display, as well as the precision of the lithography processes that may be used to form the transistors in the flat panel display. Moreover, the cost of making active matrix liquid crystal flat panel displays increases rapidly when the length of the screen diagonal exceeds 1 meter, and plasma displays are too expensive to be implemented in many contexts. Accordingly, conventional flat panel video displays are typically utilized to display images over a relatively small area and/or at a relatively small magnification level.

Video projection displays (or video projectors) may be used to magnify relatively small images and project them on a much larger screen. For example, a video projector may be used to magnify an image provided by a 2″×2″ liquid crystal display driver and project the image onto a much larger screen, e.g. a screen with dimensions of 50 to 70 inches. Video projection displays are typically much cheaper than a flat panel video display capable of providing the same final image size. However, front-screen projection is inconvenient to implement and generally provides for insufficient contrast against bright ambient illumination. Rear-screen projection displays, on the other hand, are rarely thinner than 30 cm, which may limit them to implementation in environments where there is a relatively large amount of space to position the rear-screen projection display.

Flat panel video displays that project an image using a wedge-shaped waveguide may combine many of the advantages of conventional flat panel video displays and video projection displays. FIG. 1 conceptually illustrates a conventional wedge-shaped waveguide 100 that may be used in a flat panel video display. The wedge-shaped waveguide 100 is typically formed of a low-cost pane of glass such as Pyrex. In the illustrated embodiment, a first light ray 105 is injected into the wedge-shaped waveguide 100 at a first injection angle 110. The first light ray 105 propagates through the wedge-shaped waveguide 100 until it reaches a first surface 115 of the wedge-shaped waveguide 100. The first light ray 105 impinges on the first surface 115 at an angle 120 relative to the normal 125 that is greater than the angle required for total internal reflection. Accordingly, the first light ray 105 is reflected internally and continues to propagate through the wedge-shaped waveguide 100 until it reaches a second surface 130 where it is again reflected internally.

The angle between the first surface 115 and the second surface 130 causes the first light ray 105 to impinge on the first surface 115 at progressively smaller angles relative to the normal 125. After a number of internal reflections, the first light ray 105 impinges upon the first surface 115 at an angle 135 relative to the normal 125 that is smaller than the angle required for total internal reflection, and the first light ray 105 emerges from the wedge-shaped waveguide 100. The illustrated embodiment also shows a second light ray 140 that is injected into the wedge-shaped waveguide 100 at a second injection angle 145, which is smaller than the first injection angle 110. Accordingly, the second light ray 140 impinges on the first surface 115 at a larger angle relative to the normal 125 and requires fewer internal reflections before angle 150 is smaller than the angle required for total internal reflection and the second light ray 140 emerges from the wedge-shaped waveguide 100.

In general, light rays that are injected into the wedge-shaped waveguide 100 at larger angles relative to the normal 125 will require more internal reflections before emerging and consequently will emerge at a point further along the wedge-shaped waveguide 100. Thus, light rays may be directed to emerge from a selected point on the first surface 115 by controlling the injection angle relative to the normal 125 of the wedge-shaped waveguide 100, as well as the position along a surface 155 of the wedge-shaped waveguide 100. An image may therefore be created on the first surface 115 by appropriately modulating the light rays that are injected into the wedge-shaped waveguide 100. Furthermore, if the relative angle between the first surface 115 in the second surface 130 is small, e.g., much less than 5°, the image that is seen on the first surface 115 will be magnified relative to the size of the image that was injected at the surface 155.

However, projecting and/or magnifying images using a wedge-shaped waveguide 100 may lead to a relatively large amount of undesirable chromatic dispersion. Furthermore, the light rays do not emerge perpendicular to the first surface 115, i.e. they do not emerge traveling in the direction of a likely viewer, and so the intensity of the image formed from the light that emerges from the first surface 115 may be reduced and is dependent on viewing angle. To get rid of this problem, a diffuser screen is often necessary.

### SUMMARY OF THE INVENTION

The present invention is directed to addressing the effects of one or more of the problems set forth above. The following presents a simplified summary of the invention in order to provide a basic understanding of some aspects of the invention. This summary is not an exhaustive overview of the invention. It is not intended to identify key or critical elements of the invention or to delineate the scope of the invention. Its sole purpose is to present some concepts in a simplified form as a prelude to the more detailed description that is discussed later.

In one embodiment of the instant invention, an apparatus is provided for optically addressing and a driving a luminescent display. The apparatus includes a waveguide having at least first, second, and third surfaces, the second and third surfaces being opposite each other. The apparatus also includes at least one pixel deployed proximate the second surface such that at least one light ray provided to a first location on the first surface of the waveguide at a first angle relative to the first surface emerges at a second location on the second surface of the waveguide proximate said at least one pixel. The second location is determined based on the first angle.

In another embodiment of the present invention, a method is provided for optically addressing a luminescent display. The method includes providing at least one light ray to a first location on a first surface of a waveguide at a first angle relative to the first surface such that said at least one light ray emerges from a second location on a second surface of the waveguide proximate at least one pixel. The second location is determined based on the first angle.

### BRIEF DESCRIPTION OF THE DRAWINGS

The invention may be understood by reference to the following description taken in conjunction with the accompanying drawings, in which like reference numerals identify like elements, and in which:

FIG. 1 conceptually illustrates a conventional wedge-shaped waveguide that may be used in a flat panel video display;

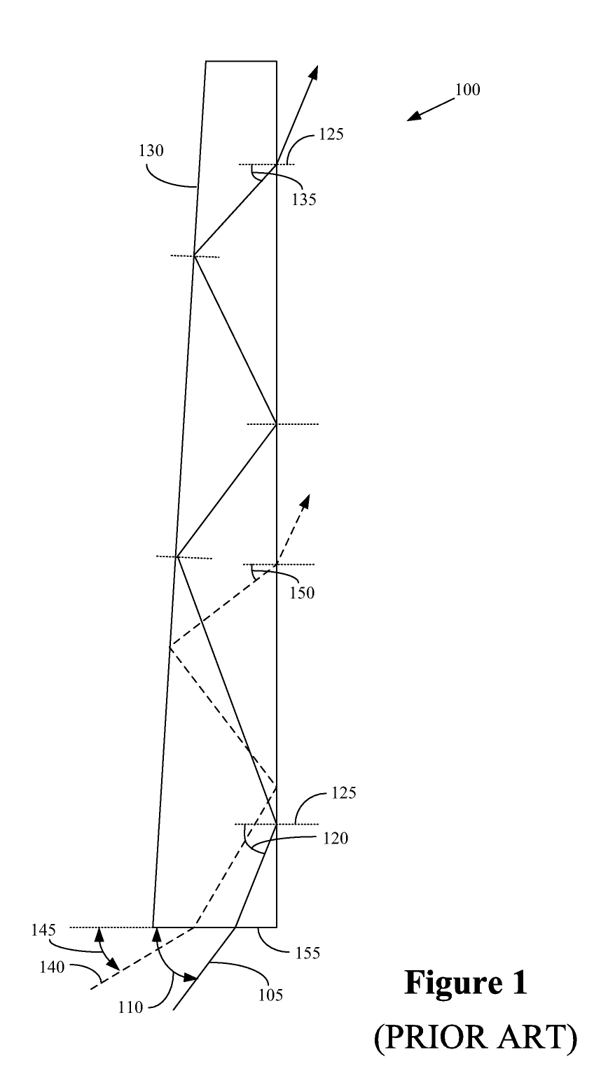

FIG. 2 conceptually illustrates one exemplary embodiment of a flat panel video display including a wedge-shaped waveguide and one or more pixels, in accordance with the present invention;

FIG. 3 conceptually illustrates one exemplary embodiment of an input image and a displayed image, in accordance with the present invention; and

FIG. 4 conceptually illustrates one exemplary embodiment of a flat-panel video display, in accordance with the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions should be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The present invention will now be described with reference to the attached figures. Various structures, systems and devices are schematically depicted in the drawings for purposes of explanation only and so as to not obscure the present invention with details that are well known to those skilled in the art. Nevertheless, the attached drawings are included to describe and explain illustrative examples of the present invention. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

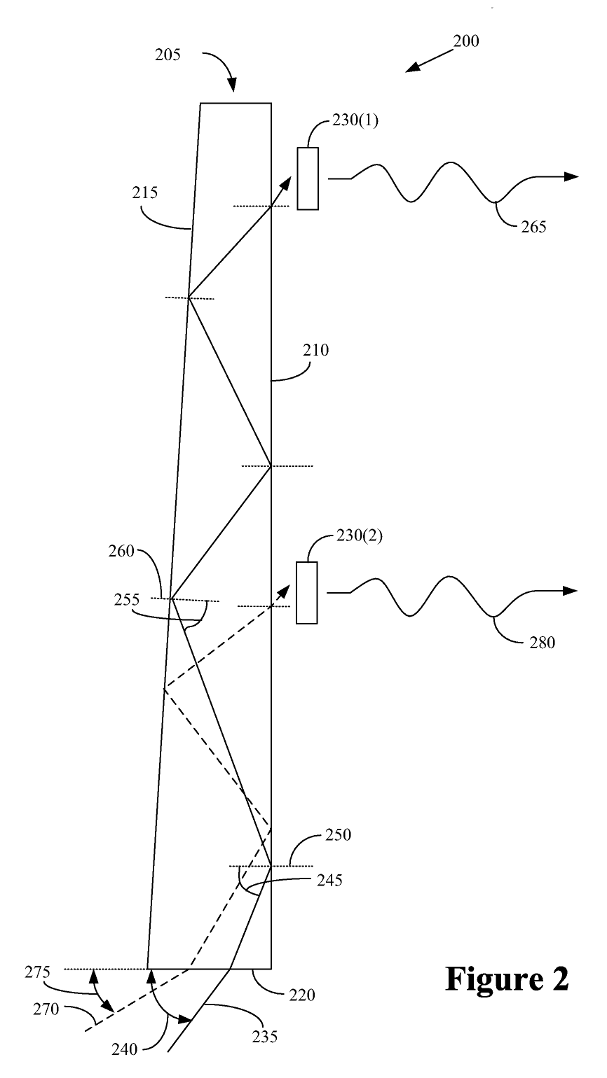

FIG. 2 conceptually illustrates one exemplary embodiment of a flat panel video display 200. In the illustrated embodiment, the flat panel video display 200 includes a wedge-shaped waveguide 205. The wedge-shaped waveguide 205 includes two opposing surfaces 210, 215 that are inclined relative to one another and at least one injection surface 220. For example, the surface 210 may be inclined relative to the surface 215 such that a difference between normal vectors to the surfaces 215 and 210 may be in a range from approximately 0.1° to approximately 5°. In various alternative embodiments, the wedge-shaped waveguide 205 may be formed of any material including, but not limited to, conventional waveguiding materials, such as glasses, Pyrex, polymers such as polysiloxane, polyacrylate, polycarbonate and the like. Persons of ordinary skill in the art having benefit of the present disclosure should appreciate that techniques for fabricating, configuring, and/or operating wedge-shaped waveguides 205 are known in the art and so only those aspects of fabricating, configuring, and/or operating the wedge-shaped waveguides 205 that are relevant to the present invention will be discussed further herein.

One or more pixels 230(1-2) are deployed proximate the surface 210 of the wedge-shaped waveguide 205. Hereinafter, the index “230” will be used to refer to the pixels 230 collectively and the indices (1-2) will be used to refer to individual pixels, e.g. the pixel 230(1), or to various subsets of the pixels 230. This convention will also be used to indicate other components that may be referred to collectively, individually, or in subsets. In the illustrated embodiment, the pixels 230 are depicted as being deployed a small distance away from the surface 210. However, persons of ordinary skill in the art should appreciate that this distance is a matter of design choice and not material to the present invention. For example, the pixels 230 may be deployed substantially on or adjacent to the surface 210. Alternatively, the pixels 230 may be separated from the surface 210 by one or more layers of material and/or empty space. Furthermore, the number of pixels 230 is also a matter of design choice.

As will be discussed in detail below, the pixels 230 may be optically driven by incident light in a selected frequency band, such as blue light and/or ultraviolet light, and produce light of a selected color in response to the incident light. For example, the pixels 230 may down-convert ultraviolet light or blue light and convert at least a portion of the energy provided by the ultraviolet light into light that may be radiated in a red, blue, or green frequency band. Although the present invention will be discussed in terms of the pixels 230, persons of ordinary skill in the art having benefit of the present disclosure should appreciate that other devices, such as quantum dots, may be optically driven by the incident light to produce light of a selected color in response to the incident light.

A first light ray 235 may be injected into the wedge-shaped waveguide 205 at a first injection angle 240 relative to the injection surface 220. The first light ray 235 propagates through the wedge-shaped waveguide 205 until it reaches the surface 210 of the wedge-shaped waveguide 205. The injection angle 240 is chosen so that the first light ray 235 impinges on the surface 210 at an angle 245 relative to the normal 250 that is greater than the angle required for total internal reflection. Accordingly, the first light ray 235 is reflected internally and continues to propagate through the wedge-shaped waveguide 205. Persons of ordinary skill in the art having benefit of the present disclosure should appreciate that the term “total internal reflection” does not necessarily imply that all of the energy in the first light ray 235 is reflected internally. For example, evanescent waves may cause some energy to leak through the surface 210 when the first light ray 235 is reflected. For another example, the light ray 235 may not be perfectly collimated and so portions of the light ray 235 may intersect the surface 215 at angles smaller than the angle required for total internal reflection.

After reflection at the surface 210, the first light ray 235 may continue to propagate through the wedge-shaped waveguide 205 until it reaches the surface 215 where it may again be reflected internally. However, the relative inclination of the surfaces 210, 215 may cause the first light ray 235 to intersect the surface 215 at an angle 255 relative to a normal 260 to the surface 215 that is smaller than the angle 245. As the first light ray 235 continues to propagate down the wedge-shaped waveguide 205, the intersection angles between the first light ray 235 and the surfaces 210, 215 (relative to the normals 250, 260 to the surfaces 210, 215, respectively) may continue to decrease because of the relative inclination of the surfaces 210, 215.

The first light ray 235 emerges from the wedge-shaped waveguide 205 when the intersection angle relative to the normal 250 becomes smaller than the angle required for total internal reflection. In the illustrated embodiment, the first light ray 235 emerges from a point on the surface 210 that is proximate the pixel 230(1). The first light ray 235 may irradiate the pixel 230(1), which may then emit light 265 in response to irradiation by the first light ray 235. For example, the pixel 230(1) may convert a portion of the energy provided by the first light ray 235 into light 265 within a selected range of wavelengths, e.g., a wavelength range corresponding to a selected color, such as red, green, or blue. In one embodiment, the wavelength range of the light 265 substantially corresponds to the wavelength range of the first light ray 235, although the wavelength ranges of the light 235, 265 may not exactly correspond to each other. Alternatively, a characteristic wavelength within the wavelength range of the light 265 may be substantially longer than a characteristic wavelength within the wavelength range of the first light ray 235, i.e., the pixel 230(1) may downconvert a portion of the energy in the first light ray 235 to form the light 265.

Accordingly, by providing the first light ray 235 at the appropriate injection angle 240, the pixel 230(1) may be selected and induced to radiate, e.g. the pixel 230(1) may be optically addressed and driven by providing the first light ray 235 to the wedge-shaped waveguide 205 at the appropriate injection angle 240. In one embodiment, the intensity of the light 265 produced by the pixel 230(1) may be proportional to the intensity of the first light ray 235. Alternatively, the intensity of the light 265 produced by the pixel 230(1) may be related to the intensity of the first light ray 235 in some other manner, e.g., there may be a nonlinear relation between the intensity of the light 265 produced by the pixel 230(1) and the intensity of the first light ray 235.

In the illustrated embodiment, a second light ray 270 may be injected into the wedge-shaped waveguide 205 at a second injection angle 275. When the second injection angle 275 is smaller than the first injection angle 240, as shown in FIG. 2, the second light ray 270 impinges on the surface 210 at a larger angle relative to the normal 250. The second light ray 270 therefore requires fewer internal reflections before the intersection angle becomes smaller than the angle required for total internal reflection. The second light ray 275 may therefore travel a shorter distance along the wedge-shaped waveguide 205 before emerging. Thus, the second light ray 275 may emerge proximate the pixel 230(2) and may be used to address and/or drive the pixel 230(2).

The pixel 230(2) may then emit light 280 in response to irradiation by the second light ray 270. For example, the pixel 230(2) may convert a portion of the energy provided by the second light ray 270 into light 280 having a selected range of wavelengths, e.g., a range of wavelengths corresponding to a selected color, such as red, green, or blue, as discussed in detail above. Persons of ordinary skill in the art having benefit of the present disclosure should appreciate that the range of wavelengths (and/or the color) of the light 265, 280 provided by the pixels 230(1-2), respectively, may be the same (e.g., the flat-panel video display 200 may be monochromatic) or different (e.g., the flat panel video display 200 may be color).

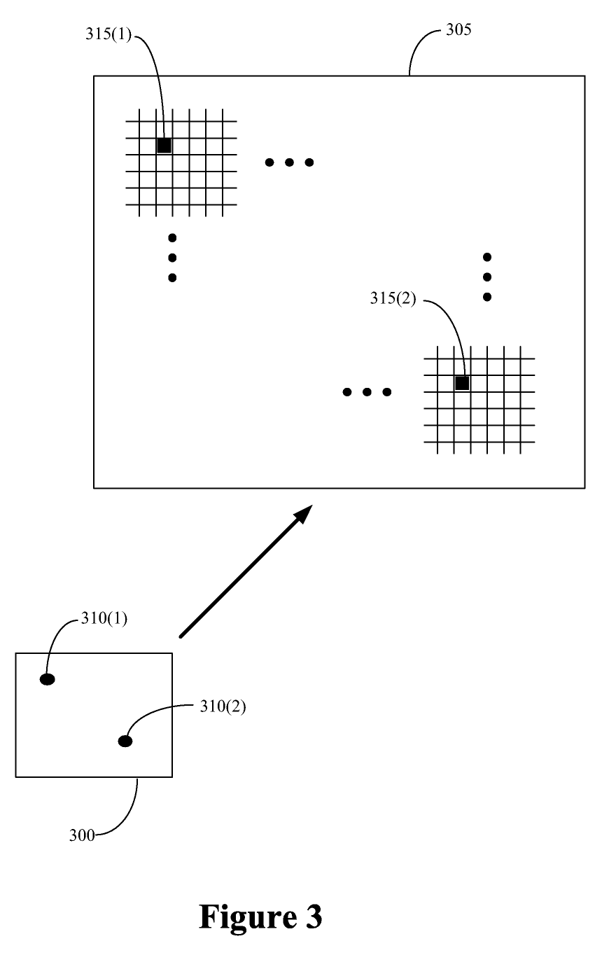

FIG. 3 conceptually illustrates one exemplary embodiment of an input image 300 and a displayed image 305. In the illustrated embodiment, the input image 300 corresponds to an image that may be provided to an injection surface of a wedge-shaped waveguide, such as the injection surface 220 of the wedge-shaped waveguide 205 shown in FIG. 2. The displayed image 305 corresponds to an image that may be produced by the light emitted by one or more pixels, such as the pixels 210 shown in FIG. 2, when they are optically addressed and driven by light associated with the input image 300.

The input image 300 includes two filled-in circles 310. A light ray associated with the filled-in circle 310(1) propagates through a wedge-shaped waveguide (not shown in FIG. 3) and irradiates a pixel 315(1), which may then radiate light, as indicated by the filled black square. A light ray associated with the filled-in circle 310(2) also propagates through the wedge-shaped waveguide and irradiates a pixel 315(2), which may then radiate light, as indicated by the filled black square. Accordingly, the input image 300 may be reproduced, and perhaps magnified or reduced or otherwise modified, to form the displayed image 305. In the illustrated embodiment, the two-dimensional input image 300 is reproduced by varying the injection angle and/or the injection point along the injection surface. For example, the vertical displacement in the displayed image 305 may be controlled by varying the injection angle and the horizontal displacement in the displayed image 305 may be controlled by varying the injection point along the injection surface. The intensity of the light ray may also be varied in some embodiments.

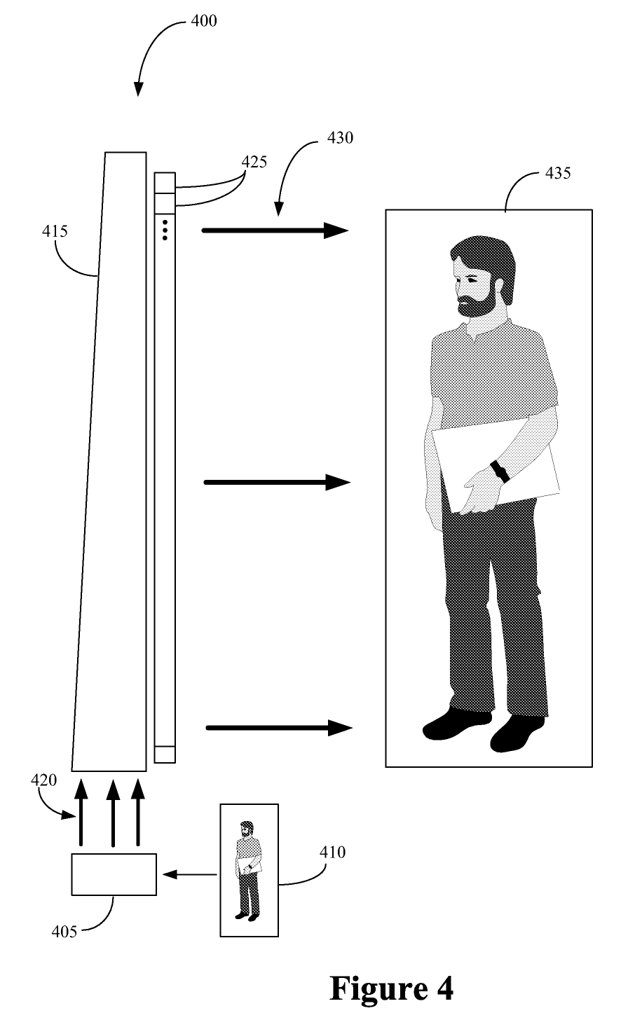

FIG. 4 conceptually illustrates one exemplary embodiment of a flat-panel video display 400. In the illustrated embodiment, the flat-panel video display 400 includes an image producing device 405. For example, the image producing device 405 may include a signal processor for producing an input image 400 and a liquid crystal display for providing the image 400 to a wedge-shaped waveguide 415. The image producing device 405 may also include one or more input ports for receiving signals that may be used to produce the input image 410. Furthermore, the image producing device 405 may include various optical devices that may be used to provide the image 400 to the wedge-shaped waveguide 415. However, persons of ordinary skill in the art having benefit of the present disclosure should appreciate that the actual implementation of the image producing device 405 is a matter of design choice and not material to the present invention, provided that the image producing device 405 is capable of providing one or more light rays 420 to the wedge-shaped waveguide 415 in the manner discussed herein.

The light rays 420 are provided to the wedge-shaped waveguide 415 at a corresponding plurality of injection angles and/or injection points so that each light ray 420 may address and/or drive one or more pixels 425. In response to irradiation by one or more light rays 420, one or more of the pixels 425 may radiate light 430 to form a displayed image 435 that corresponds to the input image 410. In the illustrated embodiment, the pixels 425 (and the displayed image 435) are monochromatic. However, persons of ordinary skill in the art having benefit of the present disclosure should appreciate that, in alternative embodiments, the pixels 425 may be capable of producing more than one color of light. For example, the pixels 425 may be capable of producing red, green, and/or blue light. Accordingly, a color displayed image 435, which may or may not correspond to a color input image 410, may be produced by providing the light rays 420 at the appropriate injection angles, injection points, and/or intensities.

Optically addressing and driving pixels as described above may have a number of advantages over conventional practice. For example, optical addressing removes the need to electrically address each pixel as is done in liquid crystal displays (LCDs) and standard cathode ray tube (CRT) displays, which may reduce the cost of building and/or operating displays that implement optical addressing of pixels. Optical addressing and driving may also reduce chromatic dispersion, relative to conventional wedge displays, and reduce viewing angle dependence relative to conventional wedge displays and LCD displays. Displays that implement optical addressing and driving may also use a single color driver. In contrast, high end digital light processing (DLP) devices often use three driver chips, one for each of the three needed color channels.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed:

1. A method, comprising:
providing at least one light ray to a first location on a first surface of a waveguide at a first angle relative to the first surface such that said at least one light ray emerges from a second location on a second surface of the waveguide proximate at least one pixel, the second location being determined based on the first angle, such that said at least one pixel radiates energy in a selected range of wavelengths.

2. The method of claim 1, wherein providing said at least one light ray to the second location proximate said at least one pixel comprises providing said at least one light ray such that said at least one pixel radiates energy in a range of wavelengths corresponding to a range of wavelengths of said at least one light ray.

3. The method of claim 1, wherein providing said at least one light ray to the second location proximate said at least one pixel comprises providing said at least one light ray such that said at least one pixel radiates energy in a range of wavelengths having a characteristic wavelength that is longer than a characteristic wavelength within a range of wavelengths of said at least one light ray.

4. The method of claim 1, wherein providing said at least one light ray at the first angle comprises providing said at least one light ray at the first angle so that said at least one light ray is totally internally reflected at least once by the second surface of the waveguide and at least once by a third surface of the waveguide, the third surface of the waveguide being opposite the second surface.

5. The method of claim 4, wherein providing said at least one light ray at the first angle comprises providing said at least one light ray at the first angle so that said at least one light ray emerges from the waveguide substantially after being totally internally reflected at least once by the second surface of the waveguide and at least once by the third surface of the waveguide.

6. The method of claim 1, wherein providing said at least one light ray comprises providing said at least one light ray in a first frequency range.

7. The method of claim 6, wherein providing said at least one light ray in the first frequency range comprises providing said at least one light ray in at least one of a blue frequency range or an ultraviolet frequency range.

8. The method of claim 1, wherein providing said at least one light ray comprises providing said at least one light ray having a first intensity.

9. The method of claim 8, wherein providing said at least one light ray having a first intensity comprises providing said at least one light ray to said at least one pixel such that said at least one pixel radiates at a second intensity.

10. The method of claim 1, wherein providing said at least one light ray comprises providing a plurality of light rays to a plurality of first locations on the first surface of the waveguide at a corresponding plurality of first angles relative to the first surface.

11. The method of claim 10, wherein providing the plurality of light rays to the plurality of first locations at the corresponding plurality of first angles comprises providing the plurality of light rays to the plurality of first locations at the corresponding plurality of first angles based upon a first image.

12. The method of claim 11, wherein providing the plurality of light rays to the plurality of first locations at the corresponding plurality of first angles comprises providing the plurality of light rays to the plurality of first locations at the corresponding plurality of first angles such that the plurality of light rays activate a plurality of pixels on the second surface to produce a second image corresponding to the first image.

13. The method of claim 12, wherein providing the plurality of light rays to the plurality of first locations at the corresponding plurality of first angles such that the plurality of light rays activate a plurality of pixels on the second surface to produce the second image corresponding to the first image comprises providing the plurality of light rays to produce at least one of a second monochromatic image and a second color image corresponding to the first image.

14. An apparatus, comprising:
means for providing at least one light ray to a first location on a first surface of a waveguide at a first angle relative to the first surface such that said at least one light ray emerges from a second location on a second surface of the waveguide proximate at least one pixel, the second location being determined based on the first angle, such that said at least one pixel radiates energy in a selected range of wavelengths.

15. An apparatus comprising:
a waveguide having at least first, second, and third surfaces, the second and third surfaces being opposite each other; and
at least one pixel deployed proximate the second surface, said at least one pixel being configured to radiate energy in a selected range of wavelengths in response to at least one light ray emerging at a second location on the second surface of the waveguide proximate said at least one pixel when said at least one light ray is provided to a first location on the first surface of the waveguide at a first angle relative to the first surface.

16. The apparatus of claim 15, wherein the waveguide comprises at least one of a glass, a polymer, a polysiloxane, a polyacrylate, and a polycarbonate.

17. The apparatus of claim 15, wherein the second and third surfaces are oriented so that said at least one light ray is totally internally reflected at least once by the second surface of the waveguide and at least once by a third surface of the waveguide.

18. The apparatus of claim 17, wherein the second and third surfaces are oriented so that said at least one light ray emerges from the second surface substantially after being totally internally reflected at least once by the second surface of the waveguide and at least once by a third surface of the waveguide.

19. The apparatus of claim 15, wherein said at least one pixel is configured to radiate energy in a range of wavelengths corresponding to a range of wavelengths of said at least one light ray.

20. The apparatus of claim 15, wherein said at least one pixel is configured to radiate energy in a range of wavelengths having a characteristic wavelength that is longer than a characteristic wavelength within a range of wavelengths of said at least one light ray.

21. The apparatus of claim 15, comprising a plurality of pixels deployed proximate the second surface of the waveguide.

22. The apparatus of claim 21, wherein the plurality of pixels radiate in at least one selected wavelength range when irradiated by at least one of a plurality of light rays provided to a plurality of first locations on the first surface of the waveguide at a corresponding plurality of first angles relative to the first surface such that the plurality of light rays emerge at a plurality of second locations on the second surface of the waveguide, each of the plurality of second locations being proximate at least one of the plurality of pixels.

23. The apparatus of claim 22, wherein the plurality of pixels form a first image corresponding to a second image used to provided the plurality of light rays to the plurality of first locations on the first surface of the waveguide.

24. The apparatus of claim 23, wherein the plurality of pixels form at least one of a first monochromatic image and a first color image.
